(19) United States
(12) Patent Application Publication
(10) Pub. No.: US 2002/0065097 A1
(43) Pub. Date: May 30, 2002

(54) System for arranging interactive games between players via multimode communication devices

(76) Inventors: Allan E. Brockenbrough, S.Hamilton, MA (US); Mark J. Vincent, North Andover, MA (US); Lynda L. Chang, Watertown, MA (US)

Correspondence Address: STAAS & HALSEY LLP, 700 11TH STREET, NW, SUITE 500, WASHINGTON, DC, 20001, US

(21) Appl. No.: 09/726,245

(22) Filed: Nov. 30, 2000

(51) Int. Cl. H04M 1/00

(52) U.S. Cl. 455/552; 455/412; 455/425; 379/93.09

(57) ABSTRACT

A system for managing a competitive activity between first and second competitors, each of whom has a multimode communication device. The first competitor is provided with a predetermined list of competitors, such as a friends list which has been stored in advance by the first competitor. The first competitor is requested to select at least one competitor from the predetermined competitor list as a second competitor via the first multimode communication device. A competitive activity is then arranged involving the first and second competitors via the first and second multimode communication devices. The competitive activity may be a parlor game, a gambling or wagering game, a debate or any other type of competitive activity. In addition, if one of the competitors receives a voice telephone call while their multimode communication device is in a data mode for conducting the competitive activity, the competitor is notified of the incoming voice telephone call. In addition, if the competitor who has received the call accepts the voice telephone call, then any other competitor is notified that the called competitor has accepted the voice telephone call.

### BACKGROUND OF THE INVENTION

The present invention is directed to assembling multimode communication device users, such as wireless telephone users, together for the purpose of playing interactive games using the multimode communication device for game input and game output, and more particularly for sending game invitations between wireless telephone users to allow the users to join an interactive wireless telephone game and for allowing the game to be suspended when one of the players in the game accepts a voice telephone call.

Many wireless telephones, such as a Mitsubishi T250 (CDPD) telephone subscribing to the AT & T PocketNet service and several Sprint PCS (CDMA—Code Division Multiple Access) telephones subscribing to the Sprint Wireless Web (HDML—Handheld Device Mark-up Language) telephone service, include microbrowsers that enable users of the telephones to access the Internet using a language such as WML (Wireless Mark-up Language). These microbrowsers, provided by companies such as Phone.com, typically communicate with a gateway computer. The gateway computer receives requests for information from the microbrowsers, fetches the information on behalf of the users, formats the information for display on the small screens of the users' telephones, and sends the formatted information to the microbrowsers. Such a gateway computer is available from Phone.com of Redwood City, Calif. Cellular Digital Packet Data (CDPD) is a well-known system by which wireless devices, such as a wireless telephone, can send and receive data over an existing cellular network. CDPD, sometimes in conjunction with the Internet, can provide a data connection between these microbrowsers and the gateway computer.

Using the above-described approach, companies such as Nokia, have developed interactive wireless telephone games. In these games, wireless telephone users, also known as mobile clients, use the Internet to access a game site or server. The game server formats game information and sends the game information to the microbrowser. Through this interaction between the mobile client and the game server, a mobile client can play a game. The game can be played with just one mobile client, such as solitaire, or can involve multiple players, such as checkers.

Many mobile clients may want to play a game only with other mobile clients that they know. Furthermore, some mobile clients may want to receive invitations to play games only from other users that they know. Thus, there is a need for a method of allowing mobile clients to invite other mobile clients into a game. In addition, there is a need to provide mobile clients with the ability to block unwanted invitations so that only invitations from a selected list of mobile clients are received, and so that unsolicited invitations are not received. Thus, there is a need for better management of the game formation process.

Many of today's wireless telephones are capable of operating in two modes, a voice mode and a data mode. Wireless telephones that are capable of using CDPD can operate in only one mode at a time, i.e., these telephones must switch between voice and data. While in the data mode, such as when using the microbrowser to access the Internet, these telephones cannot make or receive voice calls. To solve this problem, Internet call waiting products of the type described in copending U.S. application Ser. No. 09/614,717 filed Jul. 12, 2000 by Safi et al., entitled “System for Providing Internet Call Waiting For Digital Cellular Telephones,” give the mobile client the option of taking a voice call. However, such products do not address the problems which occur when one of the participants in a game being played between mobile clients receives a call.

If one of the participants in the game receives a call while a game is being played between at least two mobile clients, other players must wait until the call is over for the mobile client to make his move. Currently, mobile game providers do not inform other mobile client game players that a player has taken a call. Thus, there is a need in the art to provide a system which is capable of informing other players when a called player becomes engaged in a telephone call, so that the other players can make decisions about the game, such as removing the player from the game or waiting for the player to reenter the game.

### SUMMARY OF THE INVENTION

In one aspect, the present invention seeks to overcome the disadvantages of the prior art described above by providing an improved method for sending an invitation inviting another mobile client to engage in a competitive activity such as a game via wireless telephones.

In another aspect, the present invention also seeks to provide the capability for mobile clients to accept such invitations to join an existing competitive activity, such as a wireless telephone game.

In another aspect, the present invention also seeks to provide a mobile client with the ability to block an invitation to engage in a competitive activity so that only invitations from a selected list of potential competitors are received.

In another aspect, the present invention also seeks to provide the capability of informing competitors engaged in a competitive activity if one of the other competitors takes a voice telephone call, effectively leaving the competitive activity.

One feature of the present invention relates to the formation of competitive activities between a first competitor having a first multimode communication device, and other competitors. The first competitor is provided with a predetermined list of one or more potential competitors and selects at least one of the competitors from the list of potential competitors as a second competitor via the first multimode communication device. A competition is then formed between the first competitor and the selected second competitor via first and second multimode communication devices.

Another feature of the present invention relates to notification to a first competitor who receives a voice telephone call and notification of other competitors when the first competitor accepts the call. If a first multimode communication device is in a competitive activity mode when a voice telephone call to a user of the first multimode communication device is attempted, the user of the first multimode communication device is informed of the voice call. If the user of the first multimode communication device accepts the voice telephone call, the user of the second multimode communication device is notified.

These together with other features and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts the components of the present invention.

FIG. 2 is a diagram showing the flow of information between components when joining mobile clients together in a game in accordance with the present invention.

FIG. 3 is a flow chart which depicts the process of joining mobile clients together in a game in accordance with the present invention.

FIG. 4 is a diagram depicting the flow of information between components when a player accepts a voice telephone call during a game in accordance with the present invention.

FIG. 5 is a flow chart illustrating the process which occurs when a player accepts a telephone call during a game in accordance with the present invention.

FIG. 6 illustrates sample mobile client cards (i.e., formatted information screens), which are generated in accordance with the present invention.

### DESCRIPTION OF THE PREFERRED EMBODIMENTS

As described generally above, the present invention is directed to improvements in arranging and conducting competitive activities between competitors via multimode communication devices. In the detailed description provided below, the multimode communication devices are described as wireless telephones. However, the present invention is not limited to wireless telephones but could also be applicable to multimode communications devices, including, but not limited to, PC and cable devices. In addition, the features of the invention are directed to any competitive activity. While the description provided below provides the example of a game, the features in the present invention are not limited to games but are also applicable to other types of competitive or sequential participation activities, such as round-robin activities, turn-taking activities, etc. Examples of competitive activities to which the features of the present invention may be applied, include parlor games such as hearts, bridge and checkers; gambling games such as black jack and poker; competitions relating to fantasy sports leagues such as fantasy sports drafts and trading; auctions; and debates. In general, the features of the present invention can be applied to any type of competitive or sequential participation event.

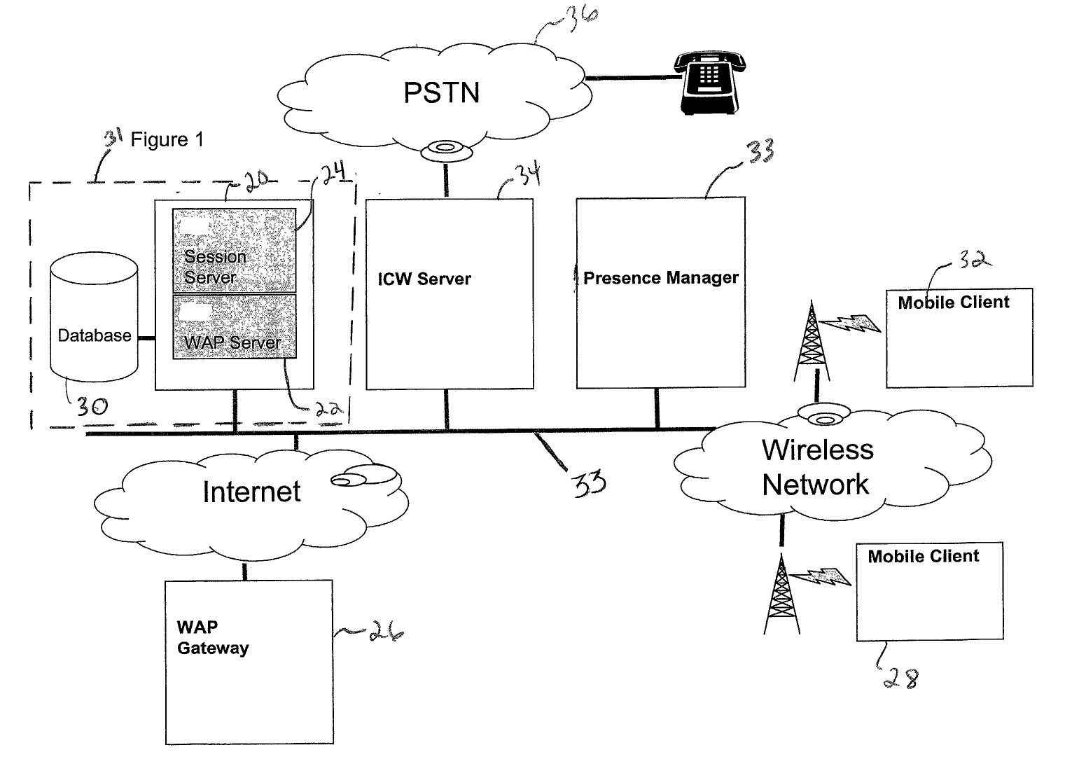

Referring to FIG. 1, a physical host 20, such as a PC running Windows, or a Sun Work Station running Unix, contains both a WAP (Wireless Application Protocol) server 22 and a session server 24. As is well known in the art, there are a number of ways to host servers on the physical host 20. For example, the WAP server 22 could run on a separate host from the session server 24. In addition, if there is a heavy mobile client load, there may be multiple WAP servers 22 or session servers 24. In addition, the various servers could all be on the same machine or on separate machines depending on the load.

The WAP server 22 is used to send information to a WAP gateway 26 that is then forwarded to a mobile client. In response to a request (URL) from the mobile client, the web server will respond via the Internet with static and dynamically generated formatted information. This information is formatted using the wireless mark-up language (WML) and the formatted page of information which is displayed to a user is referred to as a card. While the invention is described using WAP and WML protocols, other protocols could be used in connection with the features of the present invention. In particular, any protocol that supports transmission and presentation of data over mobile lines and the presentation on mobile handsets can be used. An example of an alternative protocol is i-mode, a packet based communication protocol based on cHTML (compact hypertext markup language). The i-mode service is offered by NTT DoCoMo, a Japanese telecommunications company.

In operation, the WAP gateway 26 forwards WAP requests (URLs) received from a mobile client, (for example, a mobile client 28) to the WAP server 22. The WAP server 22 sends response information to the WAP gateway 26 which in turn forwards the information to the mobile client 28. In particular, the URL request goes to a cell tower through the wireless network to the WAP gateway 26 which forwards the URL request to the session server 24. Ultimately, the session server 24 obtains a response and sends it back on the reverse path to the WAP gateway 26 over the cell tower out to the mobile client. The mobile client 28, which could be, for example, a wireless telephone, is loaded with an appropriate browser (e.g., a WAP browser) which displays a response card or page.

The WAP server 22 requests information from the session server 24 to generate reformatted response cards. The session server 24 is used to manage games being formed, retrieving and modifying friend lists, sending invitations to friends, tracking whether mobile clients are accepting invitations, and retrieving pending messages for display. The session server 24 manages these tasks by storing game and player information in a database which is used to store game information, friend information, availability for invitations, pending invitations, and pending messages. The physical host (which includes the session server 24 and the WAP server 22) and the database 30 together form a competition control unit 31. Each mobile client can set whether they want to receive all invitations, no invitations, or invitations only from friends. These settings are stored in the database 30. Each of the mobile clients can adjust their position regarding the acceptance of invitations by going to a web page and causing a change in their invitation acceptance list within the database 30. Alternatively, each of the mobile clients can also adjust their position regarding the acceptance of invitations through WAP requests. As described above, although the features of the invention are described below primarily in terms of the use of the invention to form and conduct games, in fact, the features of the present invention are applicable to any competitive, sequential participation, turn-taking or round-robin activities. Further, the features of the invention can be applied to any WAP system, apparatus or device that has connectivity, whether wireless or wire-based, to a network operator in situations where there is only one type of communication over a channel at any one time.

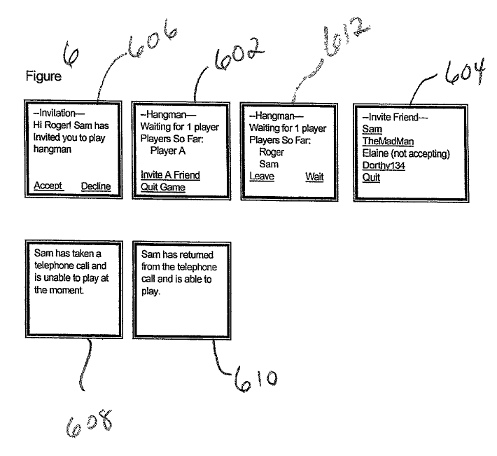

The process of joining mobile clients together, for example, mobile client 28 and mobile client 32, in a game begins when one mobile client, for example, client 28, makes a request to begin a game. This request is received by the WAP server 22 which asks the session server 24 to add to the database 30 a new game table record representing the game being formed. This game table is given a unique ID. The WAP server 22 then forms a response card such as response card or page 602 in FIG. 6. This advises mobile client 28 that the WAP server 24 is waiting for one player and invites mobile client 28 to invite a friend. This allows mobile client 28 to make a request to invite other players to the game. The WAP server 40 then requests a list of friends stored in the database 30 for mobile client 28.

This list defines a community of game players or competitors, and can be similar to a so-called buddy list which is used by PC users for instant messaging purposes. The list is a predetermined list in the sense that each of the competitors who use the system is entitled to specify in advance a list of friends, or a list of groups of friends (i.e., teams) with which they are willing to compete. Therefore, in accordance with the present invention, team lists may be created for use in group competitions.

The availability of each of the friends identified in the friends list is determined by way of a presence manager 33 which is capable of determining whether the wireless telephone for each of the friends identified on the friends list is turned on and therefore accessible. Thus, the presence manager 33 keeps track of whether a mobile client or a mobile phone is on, and in range. The presence manager 33 can take the form of any one of a number of available products, such as the IM-Anywhere™ server manufactured by Invertix of Annandale, Va. Another example of a presence server which can act as the presence manager 33 is described in copending U.S. application Ser. No. 09/698,047 filed Oct. 30, 2000 by Braudes, entitled “System For Modifying Telephone Network Call Routing Based On Presence Information,” the contents of which is hereby incorporated by reference.

The WAP server 22 formats the information from the database 30 and sends the list of friends and their availability to receive invitations back to mobile client 28 in the form illustrated by card 604 in FIG. 6. Card 604 provides a list of friends and indicates that one of the friends is not accepting invitations. Mobile client 28 can use the card to select one or more friends to invite to the game. The WAP server 22 then requests the session server 24 to send an invitation to the selected friend. For example, mobile client 32. The WAP server 22 passes the ID for mobile client 28 and the invited friends' ID (i.e., mobile client 32) as part of the request. The session server 24 sends the invitation to mobile client 32 (i.e., the wireless telephone of mobile client 32).

The form of the invitation depends on the capabilities of the wireless network and the WAP gateway 26. One way of sending the invitation is by using the Phone.com alert method. To use this alert, the session server 24 sends the ID for mobile client 32 and a URL to the WAP gateway 26. The WAP gateway 26 pushes the alert to the mobile client 22 wireless telephone. The alert appears on the wireless telephone, giving the mobile client 32 the option of viewing the associated URL. The mobile client 32 then makes the URL request to the WAP server 22 which in turn forms an invitation card such as the card 606 in FIG. 6, which invites mobile client 32 to play a game. Then, using the card, mobile client 32 is allowed to accept or decline the invitation. If the invitation is accepted, the WAP server 22 receives this acceptance and makes a request to the session server 24 to add mobile client 32 to the active game table stored in database 30. As a result, mobile clients 28 and 32 are joined together in a game. If desired, mobile client 28 may also ask additional players to join the game.

Another aspect of the present invention provides for managing the game when one of the players leaves the game (temporarily or permanently) to take a telephone call, will now be described with reference to FIG. 1. FIG. 1 illustrates an Internet Call Waiting (ICW) server 34 which is connected to the public switched telephone network (PSTN) 36. The ICW server 34 has to notify the session server 24, so that the session server 24 can notify all of the other game players when a called person takes a call. If a mobile client is in a data mode and receives a voice call, the voice call will not go through, without the ICW server 34 or some similar type of product. If the ICW server 34 is not available, the caller will get a busy signal and the call will go to voice mail. The competition control unit 31, ICW server 34 and presence manager 33 are connected via a network connection 33 to form a local area network (LAN), preferably using an Ethernet. It should be noted that the presence manager 33, ICW server 34, host 20 and database 30 may be located at one location or may be distributed over several locations. For example, these elements can be run as a platform at the site of a wireless service provider or they can be operated remotely via connection to the Internet. The ICW server 34 is described in detail in copending U.S. application Ser. No. 09/614,717, filed Jul. 12, 2000 by Safi et al., entitled “System For Providing Internet Call Waiting For Digital Cellular Telephones,” the contents which are hereby incorporated by reference. The competition control unit 31, the ICW server 34, the presence manager 33, the WAP gateway 26 and the wireless network together form a wireless communication system. The ICW server 34 receives a transferred call from a busy data enable device (DED), such as a wireless telephone operating in a data mode, and sends a wireless Internet call waiting (ICW) notification to the wireless telephone via the WAP gateway 26. DEDs are devices which have the capability to communicate with a network through a data channel. While an example of a DED is a cellular telephone that contains a WAP/HDML compliant lightweight browser, a DED is not limited to a cellular telephone and could be any DED that is capable of sending/receiving a call over a voice channel. A DED is able to operate over one or more of several different types of networks (CDPD, GSM, GPRS, W-CDMA, Edge broadband interface, UMTS, CDMA 2000, etc.).

In accordance with the present invention, if a mobile client such as mobile client 28, is playing a game (in the data mode), the ICW server 34 will send an ICW notification to the wireless phone of mobile client 28. If mobile client 28 chooses not to accept the call, they will be returned to the game and game play is considered uninterrupted. If mobile client 28 chooses to view the notification, the wireless telephone of mobile client 28 presents mobile client 28 with a menu of handling options for the call. If mobile client 28 decides to take the call, the ICW server 34 will send a notification containing the mobile client ID of mobile client 28 who has taken the telephone call, to the session server 24. When the session server 24 receives the mobile client ID of mobile client 28, the session server 24 will query the database 30 to determine if the mobile client is currently engaged in the game. If the mobile client ID is involved in a game, a message will be formed and stored in the pending message portion of the database 30 for each of the other players in the game. The message will indicate that mobile client 28 has accepted a call and will describe the disposition of their session.

Disposition options include hold, suspend, replace or drop, and may vary based on game requirements. For example, each game has a set of attributes one of which is the minimum number of players which must be available for a game to continue. The host of the game may set certain attributes such as the length of time between moves. Based on these attributes, the disposition options for a particular game are set. For example, for the game of black jack, if there are three players and one leaves to take a telephone call, the disposition of the game will be “suspend” because it is possible for the other players to continue playing, even skipping the missing player's turn. For other games, a “hold” disposition would be proper when the game cannot continue without the missing player. Thus, while the other players may take their turns, the game must be halted when the missing player's turn comes up.

In one alternative, if a game cannot continue without the current number of players, the player who is about to receive the voice call may receive a warning that the game will be terminated if the call is accepted. Another alternative disposition is the “drop” disposition which can be actuated by the remaining players if they wish to continue the game without the missing player. As a further alternative, if a particular player takes a call, that player may provide notification to the other players that he or she intends to leave the game permanently. Other dispositions may be possible. For example, it may be desirable to have a “replace” disposition in which the missing player is dropped and there is an effort to invite another player (a replacement player) into the game. While the game is being played and no players are missing, the game is considered to be in an “active” disposition. In addition, it should be noted that the “host” of the game (that is the person who initiated the game) has the capability of throwing any other player out of the game. In this case, the person who is dropped from the game will receive a message advising them that they were dropped from the game because they took the call.

When the other players in the game submit a URL request to the session server 24, the session server 24 will present the message in a card such as card 608 in FIG. 6 which indicates that one of the players has taken a telephone call and is unable to play at the moment. If the game continues and the disposition option is “suspend” then the missing player's turn is skipped. If play continues and the disposition option is “hold” then the game is stopped to wait for the return of mobile client 28.

When mobile client 28 has completed the call, they will have the option of returning to the game if this is possible (e.g., if they have not been dropped). If mobile player 28 decides to return to the game, the session server 24 will query the database 30 to determine the status of the mobile client game session. Mobile client 28 can return to the game session if the disposition stored in database 30 is “hold” or “suspend.” The message will be formed and stored in the pending message portion of the database 30 for each of the other players in the game, indicating that the mobile client 28 has returned to the game. Session server 24 will present the message to the other players in a card such as card 610 in FIG. 6 which indicates that mobile client 28 has returned from the telephone call and is able to play. Alternatively, if the database 30 indicates that the status of the mobile client game session is “replaced” or “drop” then mobile client 28 will not be allowed to rejoin the game but may begin a new game or join another game if one is available.

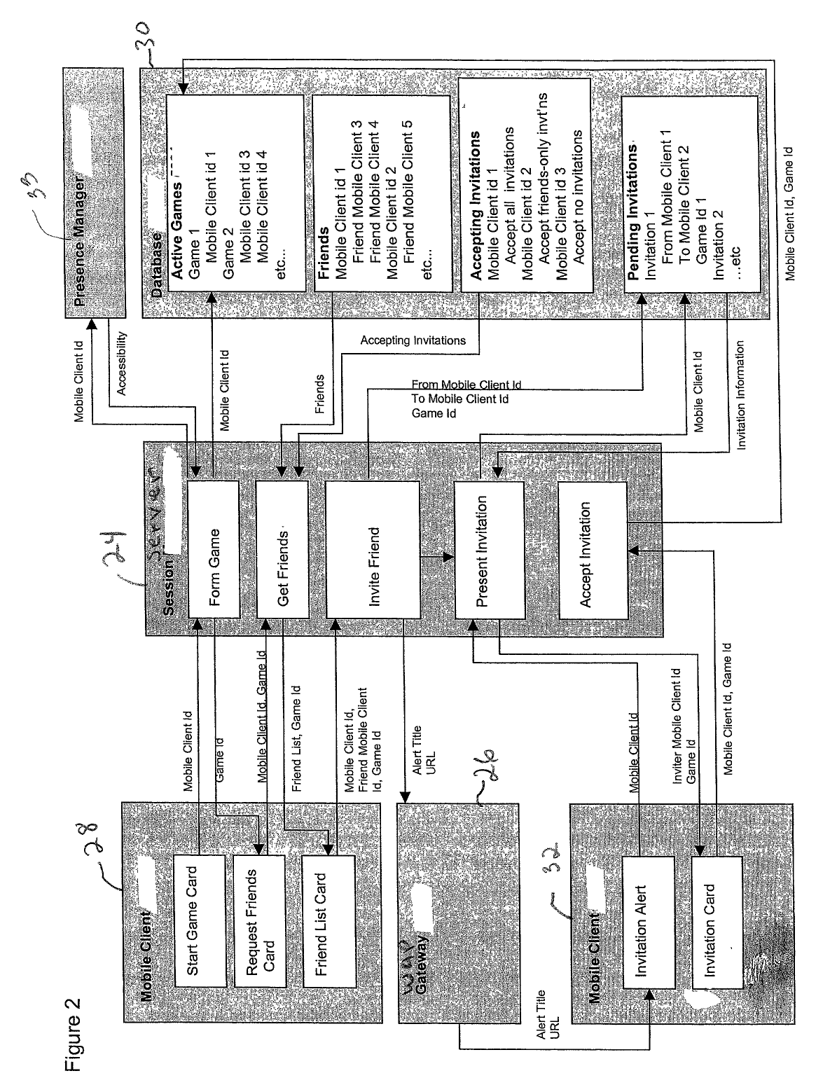

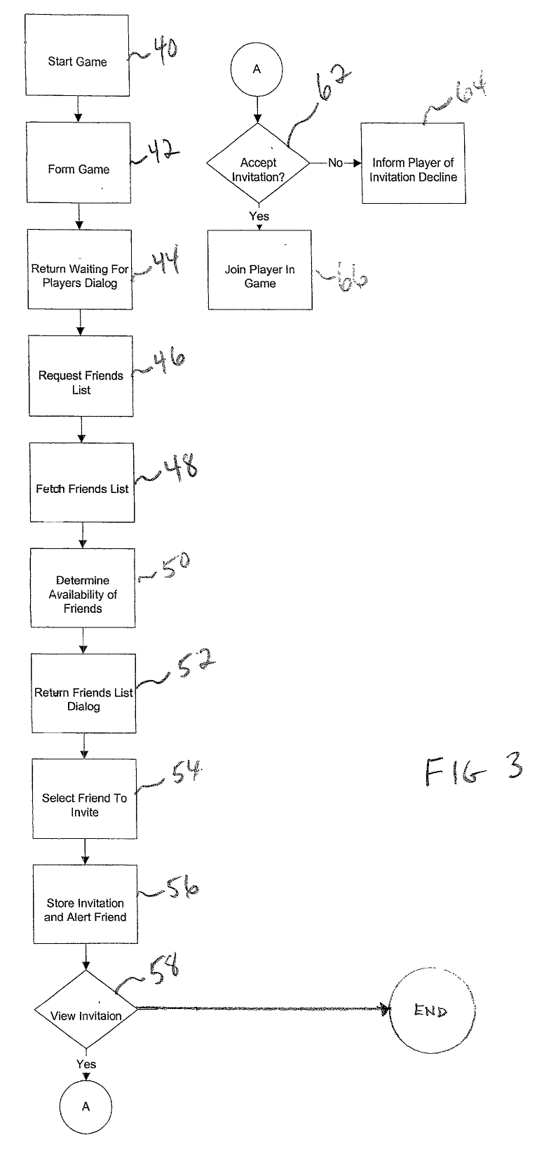

The process of inviting players to form a game in accordance with the present invention is described in detail below with reference to FIGS. 2 and 3 of the drawings. A mobile client 28 makes a request to start a game at 40 and a start game card is produced at mobile client 28. As a result, the request passes the mobile client ID for mobile client 28 to the session server 24 which forms a game at 42. The session server 24 accesses database 30 and places the mobile client ID for mobile client 28 in a new game in the active games portion of the database 30. The session server 24 then formats a card such as card 602 in FIG. 6 and sends the card to the mobile client 28 to see if mobile client 28 wants to invite a friend. This process is referenced in FIG. 3 as return waiting for players dialog at 44.

The mobile client 28 can then make a request to send a list of friends 46 at which time the mobile client ID for mobile client 28 is provided to the session server 24 which accesses the friends portion of the database 30 to retrieve the predetermined list of friends (48 in FIG. 3) corresponding to mobile client 28 and to determine which friends are accepting invitations. Thus, friends are provided with the option of accepting all invitations, accepting invitations from friends only, accepting no invitations, or specifically rejecting invitations from certain individuals. The session server 24 also contacts the presence manager 33 to determine which mobile client friends are accessible (50 in FIG. 3) or contactable (i.e., their mobile phone is on). Friends who are not accepting invitations or who are not contactable are indicated as such on the friends list. The list of friends is formatted into a card such as card 604 in FIG. 6, and provided to mobile client 28 at 52. Mobile client 28 is able to select one or more friends to invite to play the game at 54. After one friend has been selected, mobile client 28 may be presented with card 602 again, to allow mobile client 28 to select another player. Mobile client 28 selects a friend who is to receive an invitation, and the mobile client ID of mobile client 28 and the mobile client ID of the invited person (e.g., mobile client 32) are sent to the session server 24. In addition, the invited person (e.g., mobile client 32) is provided with a card 612 after joining the game, when there are still not enough players to play the game.

Next the invitation is stored and the friend (e.g., mobile client 32) is alerted at 56. Specifically, the session manager 24 records the invitation in the pending invitations portion of database 30 and the session manager 24 sends an alert to the WAP gateway 26. The alert contains a URL request that the mobile client 32 can use to view the invitation at 58. The mobile client 32 can choose not to view the invitation in which case mobile client 32 does not join the game. Alternatively, mobile client 28 may also be advised that mobile client 32 has declined to view the invitation. Alternatively, mobile client 32 can choose to view the invitation at 58 and a URL request is made to the session server 24 which receives the request and queries the pending invitation portion of the database 30 for a pending invitation for mobile client 32. The session server 24 formats the information into a card such as card 606 in FIG. 6 and sends the card to the mobile client 32. It is next determined whether the mobile client 32 accepts the invitation at 62. If the mobile client 32 does not accept the invitation, then mobile client 28 is informed that the invitation has been declined at 64. Alternatively, if the mobile client 32 accepts the invitation then mobile client 32 is joined in the game at 66. Specifically, the mobile client ID for mobile client 32 and the game ID are sent to the session server 24 which records the mobile ID as being in the given game ID in the active games portion of the database 30.

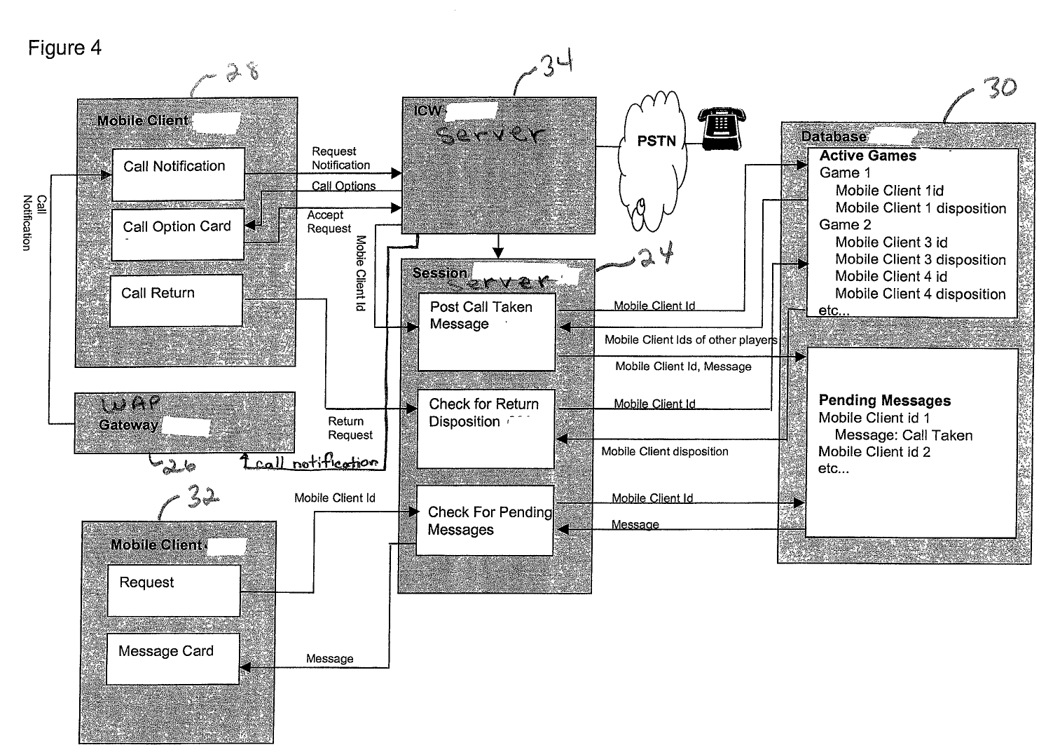

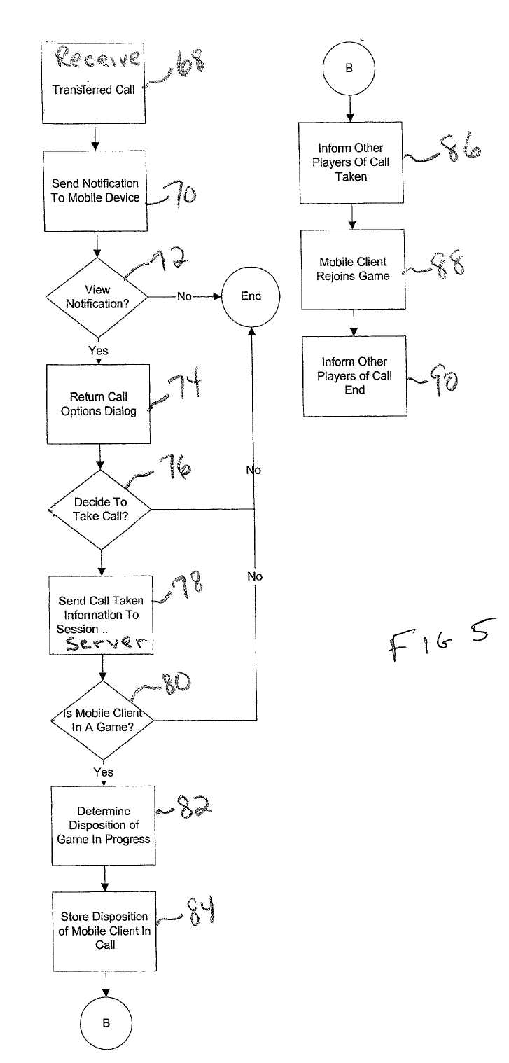

The feature of the present invention wherein one of the players in an active game is notified of an incoming voice telephone call, and wherein the game is managed so that other players are notified when one of the players has left to accept a voice telephone call, is described in detail below with reference to FIGS. 4 and 5 of the drawings.

Initially, a transferred call for mobile client 28 is received at 68. Specifically, the ICW server 34 receives a transferred call for a busy data enabled device (DED) such as the wireless telephone of mobile client 28 which is operating in the data mode (e.g., playing a game), and sends a wireless Internet call waiting (ICW) notification to the telephone of mobile client 28 via the WAP gateway 26 at 70. Based on the notification, mobile client 28 can then elect to view the notification or not view the notification at 72. If mobile client 28 elects not to view the notification then the process ends. If mobile client 28 elects to view the notification at 72 then a request is sent to the ICW server 34 which responds by providing a call option card at 74.

Mobile client 28 then decides whether or not to take the call at 76. If the mobile client 28 decides not to take the call then the process ends. If mobile client 28 decides to take the call then a request is sent to the ICW server 34 which in turn sends a notification to the session sever 24 that the mobile client 28 is taking the call. In addition, the mobile client ID for mobile client 28 is also sent to the session server 24 at 78. The session server 24 then determines whether mobile client 28 is currently in a game at 80. Specifically, session server 24 queries the active games portion of the database 30 to determine if mobile client 28 is a player in a game. If the mobile client 28 is participating in a game, then a disposition of the game in progress is determined at 82. Specifically, the session server 24 retrieves the mobile client IDs of the other players in the game and posts messages that a player has taken a call in the pending messages portion of the database 30 at 84. When another mobile client playing the game, such as mobile client 32, makes a request to the session server 24, the session server 24 checks the pending messages portion of the database 30 and formats the pending message for mobile client 32 into a card such as card 608 in FIG. 6. This advises the other players that mobile client 28 has taken a telephone call at 86.

Pending notifications can be handled in a number of different ways. For example, the mobile client can have a refresh or polling operation every two to five seconds which acts as a request to trigger the transmission of any pending notification to the mobile client. Alternatively, when a pending message is created, it can be automatically sent to the players currently involved in the game using a push operation. Further, when a pending message is received, each player can at that time choose to “hold,” “drop” etc. When mobile client 28 completes the telephone call, mobile client 28 may choose to return to a game session at 88 if the game session has a stored disposition of “hold” or “suspend.” The mobile client 28 terminating the call sends the mobile client ID to the session server 24 which queries the active games portion of the database 30 to determine if mobile client 28 is a player in the game. The session server 24 retrieves the mobile client IDs of the other players of the game and informs the other players of the end of the call at 90 by posting messages that mobile client 28 has returned from the call in the pending messages portion of the database 30.

When another player, such as mobile client 22 is playing the game, and makes a request to the session server 24 to check for pending messages, the session server 24 checks the pending message portion of the database 30 for pending messages and the pending message is formatted into a card such as card 610 in FIG. 6 which is send to the mobile client 32 to advise the mobile client 32 that mobile client 28 has returned from the telephone call and is able to play.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A wireless telephone apparatus, comprising:
a first wireless telephone having switchable data and voice mode communication capabilities, said data mode including a competitive activity mode involving communication with a second wireless telephone to engage in a competitive activity; and
a wireless telephone communication system communicating with said first wireless telephone, recognizing when said telephone is in the competitive activity mode at a time when a voice telephone call to said first wireless telephone is being attempted, and sending a notification of the voice telephone call to said first wireless telephone informing a user of said first wireless telephone about the voice telephone call.

2. An apparatus as recited in claim 1, wherein said wireless telephone communication system sends a notification to the second wireless telephone if the user of said first wireless telephone accepts the voice telephone call.

3. An apparatus as recited in claim 1, wherein said competitive activity is a game.

4. An apparatus as recited in claim 1, wherein said wireless telephone communication system suspends the competitive activity while the user of said first wireless telephone is taking the voice telephone call.

5. An apparatus as recited in claim 1, wherein said wireless telephone communication system drops said first wireless telephone from the competitive activity when the user of said first wireless telephone accepts the voice telephone call.

6. An apparatus as recited in claim 1, wherein said competitive activity is a round-robin activity.

7. An apparatus as recited in claim 1, wherein said competitive activity is a turn-taking activity.

8. An apparatus as recited in claim 7, wherein the turn-taking activity is a game.

9. A method comprising:
determining whether a first multimode communication device is in a data mode which is a competitive activity mode involving communication with a second multimode communication device to engage in a competitive activity, when a voice telephone call to a user of the first multimode communication device is attempted; and
informing the user of the first multimode communication device about the voice telephone call.

10. A method as recited in claim 9, further comprising:
informing a user of the second multimode communication device if the user of the first multimode communication device accepts the voice telephone call.

11. A method as recited in claim 9, wherein the first multimode communication device is a wireless communication device.

12. A method as recited in claim 11, wherein the wireless communication device is a wireless telephone.

13. A method as recited in claim 9, further comprising:
suspending the competitive activity while the user of the first multimode communication device is conducting the voice telephone call; and
restarting the competitive activity mode when the user of the first multimode communication device has completed the voice telephone call.

14. A method as recited in claim 9, wherein the competitive activity is a game.

15. A method as recited in claim 9, wherein the competitive activity is a debate.

16. A method as recited in claim 9, wherein the competitive activity is a fantasy sports draft.

17. A method as recited in claim 9, wherein the competitive activity is a round-robin activity.

18. A method as recited in claim 9, wherein the competitive activity is a turn-taking activity.

19. A computer readable storage controlling a computer by determining whether a first multimode communication device is in a data mode which is a competitive activity mode involving communication with a second multimode communication device to engage in a competitive activity, when a voice telephone call to a user of the first multimode communication device is attempted, and informing the user of the first multimode communication device about the voice telephone call.

20. A computer readable storage as recited in claim 19, further informing a user of the second multimode communication device if the user of the first multimode communication device accepts the voice telephone call.

21. A method comprising:
determining whether a first multimode communication device is in a data mode which is a sequential participation mode involving communication with a second multimode communication device to engage in a sequential participation activity, when a voice telephone call to a user of the first multimode communication device is attempted; and
informing the user of the first multimode communication device about the voice telephone call.

22. A method as recited in claim 21, further comprising:
informing a user of the second multimode communication device if the user of the first multimode communication device accepts the voice telephone call.

23. A method as recited in claim 22, wherein the sequential participation activity is a competitive activity.

24. A method as recited in claim 23, wherein the competitive activity is a game.

25. A method of managing a competitive activity involving a first competitor having a first multimode communication device and one or more other competitors, comprising:
providing the first competitor with a predetermined competitor list of one or more potential competitors, which has been stored in advance;
requesting the first competitor to select at least one competitor from the predetermined competitor list as a second competitor, via the first competitor's first multimode communication device, the second competitor having a second multimode communication device; and
managing a competitive activity involving the first competitor and the selected second competitor via the first and second multimode communication devices.

26. A method as recited in claim 25, further comprising determining whether the selected second competitor is available, and providing an indication of availability on the predetermined competitor list.

27. A method as recited in claim 25, wherein the first competitor list includes a list of friends with whom the first competitor desires to compete, stored in advance by the first competitor.

28. A method as recited in claim 25, wherein the predetermined competitor list includes a list of teams of competitors, so that a team competition can be formed.

29. A method as recited in claim 25, further comprising:
determining whether the first multimode communication device is in a data mode corresponding to the competitive activity when a voice telephone call to the first competitor is attempted; and
informing the first competitor via the first multimode communication device, about the voice telephone call.

30. A method as recited in claim 29, further comprising:
informing the second competitor via the second multimode communication device, if the first competitor accepts the voice telephone call.

31. A method as recited in claim 30, further comprising:
suspending the competitive activity while the first competitor is conducting a voice telephone call; and
restarting the competitive activity when the first competitor has completed the voice telephone call.

32. A method as recited in claim 25, wherein the competitive activity is a game.

33. A method as recited in claim 25, wherein the competitive activity is a debate.

34. A method as recited in claim 25, wherein the competitive activity is a fantasy sports draft.

35. A method as recited in claim 25, wherein the competitive activity is a round robin activity.

36. A method as recited in claim 25, wherein the competitive activity is a turn-taking activity.

37. An apparatus coupled to a communication network, comprising:
a first multimode communication device operated by a first competitor and coupled to the communication network;
a second multimode communication device operated by a second competitor and coupled to the communication network;
a competition control unit storing a first predetermined competitor list corresponding to the first multimode communication device, and arranging competitive activities involving multimode communication devices based on information stored in said competition control unit; and
a presence manager determining when said first and second multimode communication devices are accessible,
said competition control unit arranging a competitive activity involving said first and second multimode communication devices when said first multimode communication device makes a request to said competition control unit, and when the first predetermined competitor list in said competition control unit indicates a mutual agreement between said first and second users to compete with one another.

38. An apparatus as recited in claim 37, wherein said first and second multimode communication devices comprise first and second wireless telephones.

39. An apparatus as recited in claim 37, wherein the first predetermined competitor list stored in said competition control unit includes a list of teams of competitors, so that said competition control unit can arrange a competitive activity involving teams.

40. An apparatus as recited in claim 37, wherein the competitive activity is a round-robin activity.

41. An apparatus as recited in claim 37, wherein the competitive activity is a game.

42. An apparatus as recited in claim 37, wherein the competitive activity is a debate.

43. An apparatus as recited in claim 37, further comprising a call waiting server advising the first competitor via said first multimode communication device when a voice telephone call to said first multimode communication device is attempted.

44. An apparatus as recited in claim 43, wherein said competition control unit informs the second competitor via said second multimode communication device if the first competitor accepts the voice telephone call.

45. A computer readable storage controlling a computer to manage a competitive activity involving a first competitor having a first multimode communication device and a second competitor having a second multimode communication device, by providing the first competitor with a predetermined competitor list of one or more potential competitors, which has been stored in advance, requesting the first competitor to select at least one competitor from the predetermined competitor list as a second competitor, via the first competitor's first multimode communication device, and arranging a competitive activity involving the first competitor and the selected second competitor via the first and second multimode communication devices.
